(19) United States
(12) Patent Application Publication
(10) Pub. No.: US 2025/0251306 A1
(43) Pub. Date: Aug. 7, 2025

(54) METHOD AND SYSTEM FOR CONTINUOUS CONDITION MONITORING OF HOIST CHAINS

(71) Applicant: KONECRANES GLOBAL CORPORATION, Hyvinkää (FI)

(72) Inventors: Giuliano PERSICO, Wetter (DE); Juhani KEROVUORI, Jokiniemi (FI); Ari BERTULA, Vantaa (FI); Kiran ATTARDE, Pune (IN); Amit RAKSHE, Pune (IN); Rajesh NEHETE, Pune (IN); Kiran PATIL, Pune (IN); Prathamesh PATTAR, Pune (IN); Roope MELLANEN, Hyvinkää (FI); Kimi JOKINIEMI, Espoo (FI)

(21) Appl. No.: 18/855,190

(22) PCT Filed: Nov. 30, 2023
(86) PCT No.: PCT/EP2023/083739

§ 371 Date: Oct. 8, 2024

(30) Foreign Application Priority Data
Dec. 7, 2022 (FI) 20226081

(51) Int. Cl. G01M 13/023; B66D 3/26; G01B 7/04

(52) U.S. Cl. CPC G01M 13/023; B66D 3/26; G01B 7/046

(57) ABSTRACT

A method and system for continuous condition monitoring of a hoist chain implementation of the following steps:—detecting with at least one sensor a presence/absence of chain links and/or of teeth of a chain sprocket,—determining with an evaluation unit, using a signal obtained from the sensor(s), time intervals reflecting the presence/absence, and—determining with the evaluation unit sums of the time intervals,—determining with the evaluation unit a chain speed, and—comparing with the evaluation unit the first sum with the second sum in order to determine an elongation of the hoist chain, wherein each time interval was determined at the same chain speed.

### FIELD OF THE INVENTION

The present invention relates to a method for continuous condition monitoring of a hoist chain according to claim 1 and claim 2, a monitoring system for continuous condition monitoring of a hoist chain according to claim 11, and a chain hoist comprising such a monitoring system according to claim 16.

### BACKGROUND TO THE INVENTION

In order to prevent malfunctions of a chain hoist due to a defective hoist chain as well as accidents caused by a defective hoist chain, periodical inspections of the hoist chain are carried out to evaluate their state of wear. Common ways to monitor wear at a hoist chain are visual inspection and gauging by means of a chain gauge. The chain gauge is used to detect an increase of a chain link length, which can be the result of chain wear. However, such monitoring methods require interruption of the chain hoist operation for the time of visual inspection or gauging.

In connection with tab chains, e.g. drive chains, it is known to monitor wear on the chain using continuous condition monitoring, i.e. monitoring during operation of the chain.

The document EP 1 464 919 B1 discloses a chain wear monitoring method and apparatus for detecting chain wear on a tab chain used as a drive chain. A first sensor is arranged stationary and a second sensor is arranged movable in a longitudinal direction of the chain. Two markers, which are applied to the chain at a predetermined distance apart, trigger the sensors. Initially, i.e. when the chain is not worn or unworn, the position of the first sensor coincides with the position of a first marker and the second sensor coincides with the position of a second marker. An elongation of the chain is detected by determining a predetermined time delay between the triggering of the first and second sensors, moving the movable sensor to a position where substantially simultaneous triggering of the sensors is resumed, and measuring the distance the sensor was moved. Such method and apparatus have the disadvantage that at least one of the sensors has to be movable, wherein movable support structures are more prone to failure than non-movable support structures. Further, such method and apparatus have the disadvantage that it is necessary to apply markers to the chain, i.e. that it is only possible to monitor a predetermined chain segment.

The document WO 2008/024685 A2 discloses a chain wear monitoring device and method for detecting chain wear on a tab chain used as a drive chain. With a first sensing device the presence of a first chain portion is sensed, when this portion is at a predetermined location relative to the first sensing device. With a second sensing device a second chain portion is sensed, wherein the second sensing device is actuated in response to an output signal of the first sensing device. A degree of wear of the chain section extending between the first and second chain portions is determined by comparing a distance between the first and second chain portions with an initial (unworn) distance.

The document U.S. Pat. No. 5,563,392 A discloses a method and apparatus for monitoring wear on a tab chain. The apparatus comprises a pair of sensors positioned spaced apart along the chain, wherein the sensors are sensing the presence and absence of chain tabs. A first time interval (t₁-t₂) is determined by calculating the time difference between the actuation of the first and second sensors. A second time interval (t₁) is determined by determining the time it takes for one chain pitch to travel past one of the first and second sensors, wherein the chain pitch is the linear distance between common locations on successive tabs. A time ratio (TRₙ) of the first time interval over the second time interval is calculated. In order to determine chain wear this time ratio is compared to a predetermined value (TR₀).

The documents US 2011 093 218 A1 and EP 1 850 087 A1 disclose methods for condition monitoring of tab chains using sensors to sense distance information and determine an elongation of the respective tab chain based on the sensed distance information.

The document US 2019/0352140 A1 relates to tab chain defect monitoring in a people conveyor and the document DE 10 2016 109 968 A1 relates to a method for determining the speed of a ferromagnetically active drive tab chain.

### PURPOSE OF THE INVENTION

In view of the above, the object of the present invention is to provide a method and a monitoring system as well as a chain hoist, with which a simple and cost effective continuous condition monitoring of a hoist chain is possible.

### DESCRIPTION OF THE INVENTION

This object is achieved by a method comprising the features of claim 1 or claim 2, a monitoring system comprising the features of claim 11, and a chain hoist comprising the features of claim 16. The dependent claims as well as the following specification describe advantageous embodiments of the invention.

The invention relates to a method for continuous condition monitoring of a hoist chain comprising the steps of
a) detecting with a first sensor a presence and an absence of chain links,
b) determining with an evaluation unit, using a signal obtained from the first sensor, a first time interval reflecting the presence of a first chain link, a second time interval reflecting the absence of chain link between the first chain link and a third chain link, a third time interval reflecting the presence of the third chain link, and a fourth time interval reflecting the absence of chain link between the third chain link and a fifth chain link,
c) determining with the evaluation unit a first sum of the first time interval and the second time interval as well as a second sum of the third time interval and the fourth time interval,
d) determining with the evaluation unit a chain speed, and
e) comparing with the evaluation unit the first sum with the second sum in order to determine an elongation of the hoist chain, wherein each time interval was determined at the same chain speed.

In other words, in order to determine the difference between the two sums and thus the elongation of the hoist chain, the first sum is subtracted from the second sum, or vice versa. Hence, the second sum constitutes a reference for the first sum, or vice versa.

In case the difference between the two sums is equal to zero, the hoist chain is not elongated and hence unworn or “healthy”. Since the elongation will occur unevenly along the hoist chain, in case the difference is unequal to zero, the hoist chain or at least one chain link is elongated (local elongation), so that the hoist chain can be considered worn. However, as described below, the actual declaration as being worn in course of the application of the method can be made dependent on further circumstances.

Each sum contains two time intervals, wherein one reflects a presence and the other reflects the absence of a chain link. Each time interval is dependent on the shape and length of the chain links. However, each time interval reflecting the presence of a chain link should be the same, when the hoist chain is unworn. The same applies to each time interval reflecting the absence of chain link.

Since this first embodiment of the method is carried out with only one sensor, the consecutive first and second time intervals are determined using a signal obtained from the first sensor at a first “point in time” and the consecutive third and fourth time intervals are determined using a signal obtained from the first sensor at a second “point in time”, which is different from the first “point in time”. Therefore, the reference is constituted by signal data received from the (solely used) first sensor at another “point in time”.

There is no restriction as to the type of data the evaluation unit is to use to determine the chain speed according to method step (d). For example, the chain speed can be determined with the evaluation unit based on sensor signals or, as another example, by calculating it using a rotational speed of a motor of the chain hoist. The chain speed needs to be the same for each time interval involved in a comparison in order to avoid misinterpretation caused by chain speed changes. The time intervals cannot be compared to properly determine wear, if a difference between time intervals can also be caused by different chain speed when sensing.

The collection of the signal data for a certain chain speed is therefore interrupted, when the chain speed changes. The collection can then be continued, when the certain chain speed is resumed, i.e. the chain hoist is again operated at the certain chain speed. The same applies, when the chain speed remains constant.

Alternatively, a known delta in chain speed may be utilized, such that its effect on the signal obtained from the sensor can be considered or compensated when collecting the signal data.

The hoist chain is a link chain, which is clearly distinguished from a tab chain. The link chain comprises a plurality of chain links, which are alternately orientated in a first and second plane, wherein the first plane is arranged substantially orthogonal to the second plane. In other words, even numbered chain links are arranged in a first plane and odd numbered chain links are arranged in a second plane, wherein the second plane is oriented substantially orthogonal to the first plane.

The tab chain on the other hand has outer tabs and inner tabs as well as chain pins connecting the tabs. Each inner tab of the chain is oriented in a first plane and each outer tab is oriented in a second plane, wherein the first plane and the second plane are substantially parallel to each other. The tab chain is usually used as a drive chain, wherein the tabs are connected together in a continuous loop.

The first sensor preferably is an inductive sensor, such as a Hall sensor. Inductive sensors have the advantage that they work also in cases, where the hoist chain is contaminated with dirt or grease. The first sensor may alternatively be a mechanical switch or ultra sound sensor.

The first sensor changes its state when the hoist chain is moving in front of it. Detecting the presence of a chain link means that the respective sensor is actuated when a chain link or a portion thereof is present.

The first sensor preferably starts detecting at a leading edge of the chain link and terminates detecting at a trailing edge of the same chain link. In other words, a rising edge of a sensor pulse corresponds with the leading edge of a chain link. The rising edge respectively constitutes the beginning of the first and third time interval and the ending of the second and fourth time interval. The first and third time interval, reflecting the presence of a single chain link, can also be called “overpass time”.

The first sensor on the other hand preferably switches off at the trailing edge of a chain link and remains switched off between the trailing edge of the chain link and the leading edge of a next chain link being in the same plane. In other words, a falling edge of the sensor pulse corresponds with the trailing edge of a chain link. The falling edge respectively constitutes the ending of the first and third time interval and the beginning of the second and fourth time interval.

Hence, the hoist chain is interpreted as not worn or unworn, if the rising and falling edges of the sensor pulses or time intervals coincide or are as close to each other as possible. On the contrary, the hoist chain may be interpreted as worn, if the rising and falling edges of the sensor pulses fall apart, thus do not coincide.

Since the hoist chain is movable in two directions for lifting and lowering loads, the leading edge of the chain link with the hoist chain moving in one direction is the trailing edge, while the chain is moving into the other direction. Therefore, the collection of signal data may be separated for the two directions. The signal obtained from the sensor may alternatively be mirrored, when the chain is moving into the other direction.

The first sensor can either detect the presence of even numbered or odd numbered chain links. This is why the presence of a first chain link and the absence of chain link between the first chain link and a third chain link can be detected and not the presence of the second chain link, which is located between the first and third chain link. The first chain link can be any of the chain links of the hoist chain. However, the numbering of first, second, third chain link and so on is to be understood as consecutive chain links.

A major benefit of the method according to the invention is that condition monitoring is carried out continuously, while the chain hoist is in operation, so that an interruption of the operation only for monitoring purposes is not required. Another benefit of the method according to the invention is that a loading of the chain hoist is not affecting the condition monitoring.

The invention further relates to a method for continuous condition monitoring of a hoist chain comprising the steps of
a) detecting with a first sensor a presence and an absence of chain links,
a′) detecting with a second sensor a presence and an absence of teeth of a chain sprocket or the presence and the absence of chain links,
b′) determining with an evaluation unit, using a signal obtained from the first sensor, a first time interval reflecting the presence of a first chain link and a second time interval reflecting the absence of chain link between the first chain link and a third chain link,
b″) determining with the evaluation unit, using a signal obtained from the second sensor, a third time interval reflecting the presence of a first tooth or the presence of the first chain link or a second chain link or the third chain link and a fourth time interval reflecting the absence of tooth between the first tooth and a second tooth or the absence of chain link between the first chain link and the third chain link or between the second chain link and a fourth chain link or between the third chain link and a fifth chain link,
c) determining with the evaluation unit a first sum of the first time interval and the second time interval as well as a second sum of the third time interval and the fourth time interval,
d) determining with the evaluation unit a chain speed, and
e) comparing with the evaluation unit the first sum with the second sum in order to determine an elongation of the hoist chain, wherein each time interval was determined at the same chain speed.

This second embodiment of the method primarily differs from the first embodiment in that a second sensor is involved. Like the first sensor the second sensor preferably is an inductive sensor, but may alternatively be a mechanical switch or ultra sound sensor. The second sum is determined using time intervals, which, contrary to the first embodiment, are determined using a signal obtained from the second sensor instead of from the first sensor.

With the method involving two sensors, the determination of the first and second time intervals can be carried out at the same “point in time” as the determination of the third and fourth time intervals. In other words, with the first and second sensor being used, the reference is constituted by signal data received from the first or second sensor either at the same or, alternatively, also at another “point in time”. So, the signal of the second sensor may be used as reference for the signal of the first sensor, or vice versa.

Furthermore, with two sensors it can be determined, in which direction the hoist chain is running.

Another difference between the two embodiments of the methods is that with the second sensor it is possible to detect a part of the chain hoist different from the hoist chain, in particular the sprocket. That means, the second sensor may be placed to sense the hoist chain or may alternatively be placed to sense the sprocket.

Thus, contrary to the first embodiment, the two time intervals contained in the second sum can either reflect the presence of a sprocket tooth (third time interval) and the absence of a sprocket tooth (fourth time interval) or the presence of a chain link (third time interval) and the absence of a chain link (fourth time interval).

In case the second sensor is placed to sense the hoist chain and, thus, like the first sensor, is used to detect the presence and absence of chain links, the second sensor works in the same way as the first sensor. Hence, it is referred to what is outlined above in this regard.

The second sensor may be placed in such a way that a predetermined distance between the two sensors along the hoist chain may be equal to the distance between the leading edges of the first chain link and the third chain link. As a result, if the hoist chain is unworn, the first sensor will detect the leading edge of the first chain link at the same time as the second sensor will detect the leading edge of the third chain link.

Alternatively, the predetermined distance may be adjusted, and even amount to zero, so that the first sensor will detect the leading edge of the first chain link at the same time as the second sensor will detect the leading edge of also the first chain link or the second chain link, if the hoist chain is unworn. In this regard, the second sensor may detect the leading edge also of the first chain link, for instance, in case the first sensor and the second sensor are arranged with an angle of approximately 180° degrees between each other. On the other hand, the second sensor may detect the leading edge of the second chain link, for instance, in case the first sensor and the second sensor are arranged with an angle of approximately 90° degrees between each other.

In case the second sensor is placed to sense the sprocket and, thus, is used to detect the presence and absence of sprocket teeth, the second sensor changes its state when the sprocket is moving, i.e. rotating, in front of it.

The sprocket is used to move the hoist chain in order to lift and lower loads connected to the hoist chain. The sprocket is preferably pivoted at a housing of a chain guide and rotates to move the hoist chain. The sprocket comprises multiple of sprocket teeth, which are adapted to engage with the chain links of the hoist chain.

Detecting the presence of a sprocket tooth means that the respective sensor is actuated when a sprocket tooth or a portion thereof is present. Each time interval is dependent on the shape and length of the sprocket teeth. However, each time interval reflecting the presence of a sprocket tooth should be the same, when the hoist chain is unworn. The same applies to each time interval reflecting the absence of sprocket tooth.

Although, with the second sensor sensing the sprocket, the third time interval is likely to be different to the first time interval being determined with signal data from the first sensor and also the second different to the fourth, the first sum and the second sum should be equal to each other, while the hoist chain is in an unworn condition.

The second sensor preferably starts detecting at a leading edge of the sprocket tooth and terminates detecting at a trailing edge of the same sprocket tooth. In other words, the rising edge of a sensor pulse corresponds with the leading edge of the sprocket tooth. The rising edge respectively constitutes the beginning of the first and third time interval and the ending of the second and fourth time interval. The first and third time interval, reflecting the presence of a single sprocket tooth, can also be called “overpass time”.

The second sensor on the other hand preferably remains switched off between two sprocket teeth. In other words, the falling edge of the sensor pulse corresponds with the trailing edge of a sprocket tooth. The falling edge respectively constitutes the ending of the first and third time interval and the beginning of the second and fourth time interval.

The second sensor may preferably be positioned in such a way that it senses a part of the sprocket teeth, which is not in contact with the hoist chain and therefore does not wear, at least not as much as the hoist chain.

It is preferably foreseen that the method comprises repeating the steps a) to e) in case the chain speed changes.

The chain speed, i.e. hoisting speed, can vary during operation of the chain hoist. In order to make sure that different hoist speeds do not impair the accuracy of condition monitoring, the collection of signal data starts again when the chain speed changes.

The signal data set for a certain chain speed may then be saved separately from signal data sets for other chain speeds. The signal data collection into the respective signal data set may continue, when the certain chain speed is resumed.

This method is also not restricted in terms of the type of data the evaluation unit is to use to determine the chain speed according to method step (d). In accordance with the invention it is suggested as a preferred alternative that the chain speed is determined by comparing the signal obtained from the first sensor with the signal obtained from the second sensor.

With the foreseen comparison of the two sensor signals the chain speed, which is also determinable with the signal data of only one sensor, can be determined more precisely.

Since for a determination of the chain speed it is necessary to know the current length of the chain link(s), preferably, in a first step a change of chain speed is determined by detecting a change of the obtained signal of one of the sensors. Based on a known initial or previous chain speed, in a second step, the current chain speed is derived by considering the change in chain speed. In a third step, the comparison takes place to validate the result, using signal data gained from the other one of the sensors.

Alternatively, the chain speed may be determined by calculating it using a rotational speed of a motor of the chain hoist driving the sprocket. Also an input signal of the operation panel or hoist control system used for operating the chain hoist may be used for determining the chain speed.

It may be advantageously provided that the method includes detecting with the first sensor and/or the second sensor an air gap between the respective sensor and the hoist chain.

Preferably, the respective sensor used for detecting the air gap is an analog sensor. A size of the air gap can be determined using the signal of the sensor.

The air gap can be existent due to the mechanical construction of the chain hoist, e.g. of its chain guide. The air gap can increase due to wear of the hoist chain and/or the chain guide.

It may also be advantageously provided that the method includes determining with the evaluation unit the size of the air gap in order to take possible air gap generated deviations during detection with the respective sensor into account when determining the elongation of the hoist chain.

In other words, the information about the size of the air gap can be used to at least reduce air gap inducted deviations of the signal obtained from the sensor. Preferably, such deviations are completely extracted.

It can be preferably foreseen that the first sensor and the second sensor have different actuation sensitivities.

Due to different sensitivities the actuation of the first sensor occurs prior to or upon the actuation of the second sensor. The sensitivity is mainly related to the amount of material necessary to activate or trigger the sensor. Hence, the sensor with the lower sensitivity is triggered later and for a shorter time than the sensor with the higher sensitivity, when sensing chain links or sprocket teeth of the same size in an identical position of the sensor relative to the chain link or sprocket tooth.

Therefore, the time interval reflecting the presence of a chain link or a sprocket tooth is different for two sensors with different sensitivities, and also the time interval reflecting the absence of chain link or sprocket tooth. However, in case the hoist chain in unworn, the sum of the aforementioned time intervals is the same for the two sensors with different sensitivities.

The sensitivity may be adjusted in a way that the first and/or third time interval corresponds to the actual length of the chain link or the actual width of the sprocket tooth. In this case, the current length of a single chain link or current width of a single sprocket tooth can be determined by means of the respective time interval.

Carrying out the method using sensors with different sensitivities has the advantage that the result of the comparison is more meaningful due to a more contrasting reference formed by one of the sensor signals.

In a preferred embodiment, the first sensor and the second sensor work independently from each other.

That means that, according to this embodiment, it is not foreseen that any of the sensors, which is involved continuous condition monitoring, senses in response to one or more of the other involved sensors. In other words, the sensor is neither directly nor indirectly, e.g. via the evaluation unit, influenced by any of the other sensors or their sensor signal.

It may be advantageously provided that the method includes comparing with the evaluation unit a difference between the first sum and second sum with a predetermined threshold.

The predetermined threshold is to be understood as a limit of wear of the hoist chain, which, for instance, is acceptable to maintain safe operation of the chain hoist. The threshold is dependent on the geometry of the chain link, in particular the length and shape of the chain link.

Further, predetermined is to be understood as preset, wherein the threshold is deposited in the evaluation unit. The threshold may, for example, be input into the evaluation unit by a chain hoist operator or maintenance personnel. Manufacturing tolerances of the hoist chain and the sprocket may be taken into account when predetermining or presetting the threshold, so that the determination of wear is less prone to errors.

It may also be advantageously provided that the method includes generating, in particular with the evaluation unit, an output signal in case the difference exceeds the predetermined threshold.

The output signal shall be an indication, e.g. for the chain hoist operator or maintenance personnel, that the hoist chain is worn. The output signal can be an optical and/or acoustic output signal.

The invention further relates to a monitoring system for continuous condition monitoring of a hoist chain comprising
a first sensor, wherein the first sensor is arranged and configured to detect a presence and an absence of chain links,
a memory device configured to collect and save signals or signal data obtained from the first sensor, and
an evaluation unit configured to carry out the method according to the invention with the first sensor being involved.

The first sensor is mounted close to the monitored hoist chain and fixedly arranged in such a way that its sensor field is extending essentially orthogonal to a hoist chain moving direction. The first sensor preferably is an inductive sensor, such as a Hall sensor. Inductive sensors have the advantage that they work also in cases, where the hoist chain is contaminated with dirt or grease. The first sensor may alternatively be a mechanical switch or ultra sound sensor.

The first sensor can either produce a digital output signal or an analog output signal. In case the first sensor produces an analog output signal, it can be used to detect the air gap between the sensor and the chain as well as the size of the air gap. As described above, the information about the air gap can be used to reduce air gap inducted deviations of the signal obtain by the sensor.

The memory device can be connected to the evaluation unit, e.g. by an appropriate data or signal connection, or can be part of the evaluation unit.

It may be advantageously provided that the monitoring system further comprises a second sensor fixedly arranged at a predetermined distance from the first sensor, wherein the second sensor is arranged and configured to detect a presence and an absence of teeth of a chain sprocket or the presence and the absence of chain links, and wherein the memory device is configured to collect and save signals or signal data obtained from the second sensor, and wherein the evaluation unit is configured to carry out the method according to the invention with the first sensor and the second sensor being involved.

The second sensor is needed, if the second embodiment of the method, which involves the first and second sensors, is carried out. However, even if the monitoring system has the second sensor, also the first embodiment of the method, which involves only the first sensor, can be carried out.

The second sensor is mounted close to the monitored hoist chain or the monitored chain sprocket, respectively. The second sensor is fixedly arranged in such a way that its sensor field is extending essentially orthogonal to the hoist chain moving direction or a sprocket moving direction. In the latter case, the sensor field is extending essentially parallel to a rotation axis of the sprocket.

Like the first sensor the second sensor preferably is an inductive sensor, but may alternatively be a mechanical switch or ultra sound sensor.

The second sensor can either produce a digital output signal or an analog output signal. Preferably, one of the sensors produces a digital output signal while the other one produces an analog output signal. It is also possible that both sensors produce a digital output signal or an analog output signal.

In preferred embodiments of the monitoring system, both the first sensor and the second sensor are arranged upstream or downstream of the chain sprocket or, alternatively, the first sensor and the second sensor are arranged at different stream sides of the chain sprocket.

In other words, when viewed in the chain moving direction, the two sensors can be positioned on the same side before or behind the chain sprocket, so that both sensors are positioned at a load strand side or both sensors are positioned at a slack side of the hoist chain.

Alternatively, the sensors can be positioned at different sides of the sprocket, so that one sensor is positioned at the load strand side and the other sensor is positioned at the slack side of the hoist chain.

Independent from the before-mentioned arrangement criterion, each sensor may be positioned underneath the sprocket between the load strand side and slack side of the hoist chain or outside the “V” or “U” formed by the hoist chain.

In a preferred embodiment of the monitoring system the first sensor and the second sensor are arranged with an angle of approximately 90° degrees between each other.

In other words, the sensor field of the first sensor is in this case not only extending essentially orthogonal to the hoist chain moving direction, but also extending essentially orthogonal to the sensor field of the second sensor. Both sensors may then be arranged at the same level, so that the predetermined distance between them along the hoist chain amounts to zero. The same applies for sensors, which, for instance, are arranged with an angle of approximately 180° degrees between each other. However, if the angle between the two sensors is small or even equal to zero, then the sensors need to be arranged with a predetermined distance between each other, which is unequal to zero.

It is preferably foreseen that the first sensor has a first sensitivity and the second sensor has a second sensitivity being different from the first sensitivity.

As outlined above, due to the different sensitivities, the sensors are reacting differently on the hoist chain or sprocket moving in front of them and thus produce different sensor signals. However, different sensitivities do not lead to misinterpretation with respect to the elongation of the hoist chain, since also with different sensitivities the first sum and the second sum are the same, when the hoist chain is unworn.

Alternatively, two sensors with the same sensitivity may be used. If such sensors are mounted at different distances to the hoist chain, i.e. with different air gap between the respective sensor and the hoist chain, the same effect as with different sensitivities is achieved.

The invention also relates to a chain hoist comprising a monitoring system according to the invention, wherein the monitoring system is in particular arranged at or in a chain guide of the chain hoist.

The chain guide has a housing, in which the sprocket is located and pivoted. Due to its “narrow” design the hoist chain is guided in the chain guide. The monitoring system can be positioned inside and/or outside the chain guide. The at least one sensor of the monitoring system is preferably mounted to the outer contour of the housing, e.g. by using an adapter to optimally arrange the at least one sensor.

Apart from the chain guide, the chain hoist further comprises an electric motor, a gear box and a chain box for temporarily storing the unused part of the hoist chain.

Further, the following two methods for continuous monitoring of a chain hoist are also executable with the monitoring system described above, wherein the monitoring system may have only one sensor or two sensors.

First, it is executable a method for continuous condition monitoring of a hoist chain comprising the steps of
a) detecting with an sensor a presence and an absence of chain links during a first cycle and during a second cycle,
b) determining with an evaluation unit a first sine signal curve reflecting the presence and the absence of chain links during the first cycle using a signal obtained from the sensor,
c) determining with the evaluation unit a second sine signal curve reflecting the presence and the absence of chain links during the second cycle using a signal obtained from the sensor,
d) determining with the evaluation unit a chain speed,
e) comparing with the evaluation unit the amplitude value of the first sine signal curve with the amplitude value of the second sine signal curve at the same point in time, wherein both sine signal curves were determined at the same chain speed.

In other words, this method uses a comparison of two cycle's sine signal curves to determine, if the hoist chain is worn. In course of this method or embodiment, each cycle is to be understood as a load cycle. The two cycles are preferably consecutive cycles.

In case the hoist chain is unworn, the difference in amplitude value is zero or at least close to zero. The sine signal curves of both cycles are then substantially overlapping each other. In case the hoist chain or at least one chain link is elongated, the difference in amplitude value does not amount to zero. The sine signal curves of both cycles may then be off-set and/or may have different wavelengths. The difference in amplitude value at a certain point in time is related to such an off-set or wavelength difference.

This method or embodiment is preferably carried out with a single sensor. In case two sensors are used, their sensitivity is preferably harmonized.

Second, it is also executable a method for continuous condition monitoring of a hoist chain comprising the steps of
a) detecting with an sensor a presence and an absence of chain links,
b) determining with the evaluation unit a signal curve reflecting the presence and the absence of chain links using a signal obtained from the sensor,
c) determining with an evaluation unit a first time interval reflecting the time distance from a first median of the signal curve to a second median of the signal curve and a second time interval reflecting the time distance from the second median of the signal curve to a third median of the signal curve,
d) determining with the evaluation unit a chain speed,
e) comparing with the evaluation unit the first time interval with the second time interval, when the signal curve was determined at a constant chain speed.

In other words, for this method or embodiment time intervals between the medians of the signal curve are taken for determination of wear at the hoist chain. The medians are derived from the specific shape of the signal curve, which can be different from a sine signal curve, and mark the crests of the signal curve. This method or embodiment is independent of the amplitude.

This method or embodiment is preferably carried out with a single sensor. If two sensors are being used, their sensitivity is preferably harmonized.

Further details of the present invention will be apparent from the following description of embodiments based on the following drawings.

### LIST OF THE FIGURES

FIG. 1 shows a schematic combined (side and cross-sectional) view of a first embodiment of the monitoring system,

FIG. 2 shows a schematic view of a second embodiment of the monitoring system,

FIG. 3 shows a schematic view of a third embodiment of the monitoring system,

FIG. 4 shows a schematic view of a fourth embodiment of the monitoring system,

FIG. 5 shows a schematic view of a fifth embodiment of the monitoring system,

FIG. 6a shows schematic diagram of the signals obtained when performing the monitoring method according to a first embodiment with the second inductive sensor sensing the hoist chain and having the same sensitivity as the first inductive sensor, wherein the hoist chain is in an unworn condition,

FIG. 6b shows schematic diagram of the signals obtained when performing the monitoring method according to FIG. 6a, wherein the hoist chain is in a worn condition,

FIG. 7a shows schematic diagram of the signals obtained when performing the monitoring method according to a second embodiment with the second inductive sensor sensing the hoist chain and having a different sensitivity than the first inductive sensor, wherein the hoist chain is in an unworn condition,

FIG. 7b shows schematic diagram of the signals obtained when performing the monitoring method according to FIG. 7a, wherein the hoist chain is in a worn condition,

FIG. 8a shows schematic diagram of the signals obtained when performing the monitoring method according to a third embodiment with the second inductive sensor sensing a chain sprocket, wherein the hoist chain is in an unworn condition,

FIG. 8b shows schematic diagram of the signals obtained when performing the monitoring method according to FIG. 8a, wherein the hoist chain is in a worn condition,

FIG. 9a shows a schematic three-dimensional exploded view of a chain guide with a monitoring system comprising digital inductive sensors,

FIG. 9b shows a schematic three-dimensional view of the chain guide according to FIG. 9a,

FIG. 9c shows a further schematic three-dimensional exploded view of the chain guide according to FIG. 9a,

FIG. 10 shows a schematic three-dimensional view of a chain hoist with a chain guide according to FIG. 9a, and

FIG. 11 shows a schematic three-dimensional exploded view of a chain guide with a monitoring system comprising analog inductive sensors.

### DETAILED DESCRIPTION OF THE INVENTION

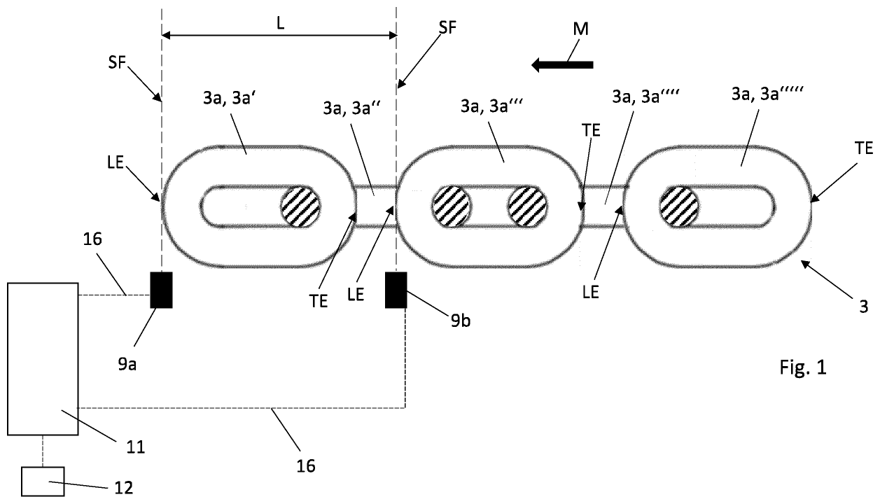

FIG. 1 shows a schematic combined (side and cross-sectional) view of a first embodiment of the monitoring system.

The monitoring system comprises a first inductive sensor 9a and a second inductive sensor 9b. The two inductive sensors 9a, 9b are connected to an evaluation unit 11 via signal connections 16 in order to transfer signals from the respective inductive sensor 9a, 9b to the evaluation unit 11. The transferred signals or signal data can be saved in a memory device 12 which is connected to the evaluation unit 11.

The two inductive sensors 9a, 9b are positioned to continuously monitor a hoist chain, which is moving in front of the two inductive sensors 9a, 9b. Although the hoist chain 3 is movable in both directions for lifting and lowering operation, for the purpose of simplification, in the depicted view, the hoist chain 3 moves in the shown chain moving direction M. The hoist chain 3 comprises multiple chain links 3a connected to each other.

The links 3a are alternately orientated in a first and second plane, wherein the first plane is oriented substantially orthogonal to the second plane. In particular, a second chain link 3a″ and a fourth chain link 3a″″ are arranged in a first plane and a first chain link 3a′, a third chain link 3a″′ and a fifth chain link 3a″″′ are arranged in a second plane.

The two inductive sensors 9a, 9b are mounted close to the monitored hoist chain 3 and fixedly arranged in such a way that their sensor fields SF are extending essentially orthogonal to the chain moving direction M. The first inductive sensor 9a and the second inductive sensor 9b are capable of detecting a presence and an absence of chain links 3a of a hoist chain 3.

With the shown arrangement of the inductive sensors 9a, 9b, both inductive sensors 9a, 9b can detect the presence of odd numbered chain links 3a, i.e. of the first chain link 3a′, of the third chain link 3a″′, and of the fifth chain link 3a″″′. On the other hand, a presence of the even numbered chain links 3a, i.e. of the second chain link 3a″, the fourth chain link 3a″″, which are located in another plane, cannot be detected by the two inductive sensors 9a, 9b.

The first inductive sensor 9a and the second inductive sensor 9b are fixedly arranged at a predetermined distance L from each other. In the shown unworn state of the hoist chain 3, the distance L amounts to the distance between a leading edge LE of the first chain link 3a′ and the leading edge LE of the third chain link 3a″′. Hence, the distance L amounts to the length of the first chain link 3a′ and a gap between the first chain link 3a′ and the third chain link 3a″′, the gap amounting to a distance between a trailing edge TE of the first chain link 3a′ and the leading edge LE of the third chain link 3a″′.

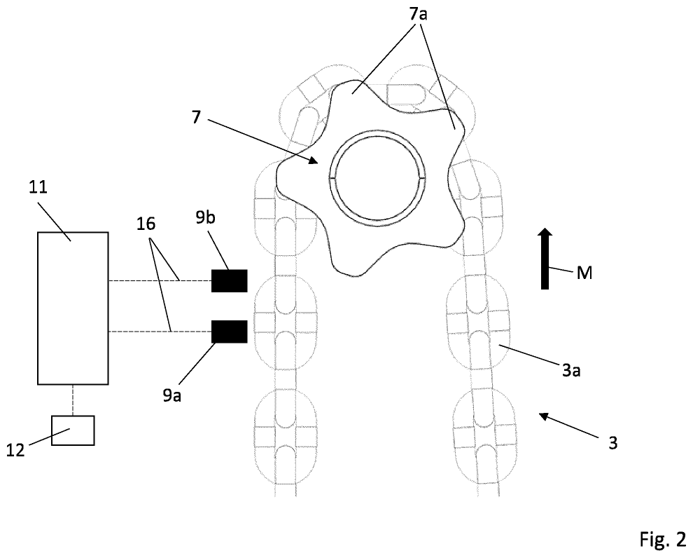

FIG. 2 shows a schematic view of a second embodiment of the monitoring system.

Similar to the first embodiment, the monitoring system according to the second embodiment comprises a first inductive sensor 9a and a second inductive sensor 9b. The two inductive sensors 9a, 9b are connected to the evaluation unit 11 via signal connections 16. The memory device 12 is connected to the evaluation unit 11.

Besides the hoist chain 3, which is moving in the chain moving direction M, a chain sprocket 7 is depicted. The chain sprocket 7 is used to move the hoist chain 3 in order to lift and lower loads connected to the hoist chain 3. The sprocket 7 has five teeth 7a, which are capable of engaging with the chain links 3a of the hoist chain 3.

Both inductive sensors 9a, 9b are arranged and configured to detect the presence and the absence of chain links 3a. Both inductive sensors 9a, 9b are arranged downstream of the chain sprocket 7. That means, if the depicted chain moving direction M is a lifting direction, both inductive sensors 9a, 9b are positioned at the slack side of the chain sprocket 7.

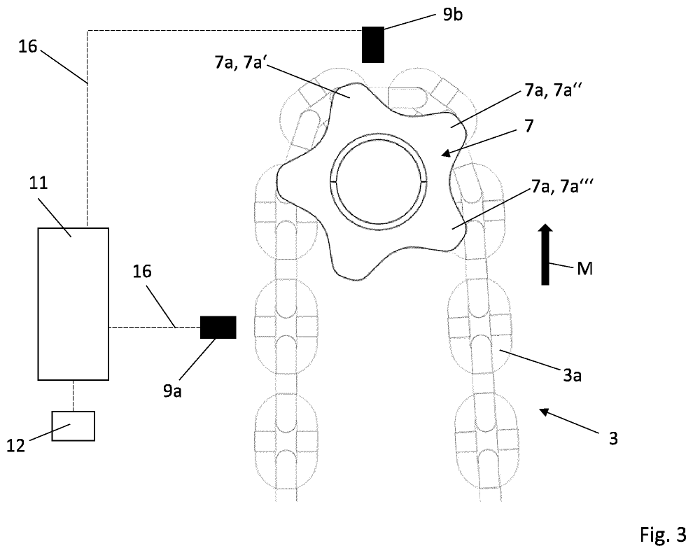

FIG. 3 shows a schematic view of a third embodiment of the monitoring system.

The monitoring system according to the third embodiment also comprises two inductive sensors 9a, 9b, which are connected to the evaluation unit 11 via signal connections 16, wherein the evaluation unit 11 is connected to a memory device 12.

The first inductive sensor 9a is—like in the other two embodiments—arranged and configured to detect the presence and absence of chain links 3a. The second inductive sensor 9b is, however, arranged and configured to detect the presence and absence of teeth 7a of the sprocket 7. Hence, the second inductive sensor 9b is capable of detecting the first tooth 7a′ and second tooth 7a″ and so on as well as the absence of tooth between the first tooth 7a′ and the second tooth 7a″, between the second tooth 7a″ and the third tooth 7a″′ and so on.

Although, in the schematic view, the second inductive sensor 9b is, for simplicity reasons, depicted in such a way that it would sense the tip of the sprocket teeth 7a, the second inductive sensor 9b is actually arranged and configured to sense a part of the sprocket teeth 7a, which is not as much exposed to the hoist chain 3 as other parts of the sprocket teeth 7a, so that wear will be less than at the hoist chain 3. This allows to have a reference sensor signal obtained from the second inductive sensor 9b, which is more contrasting to the sensor signal obtained from the first inductive sensor 9a.

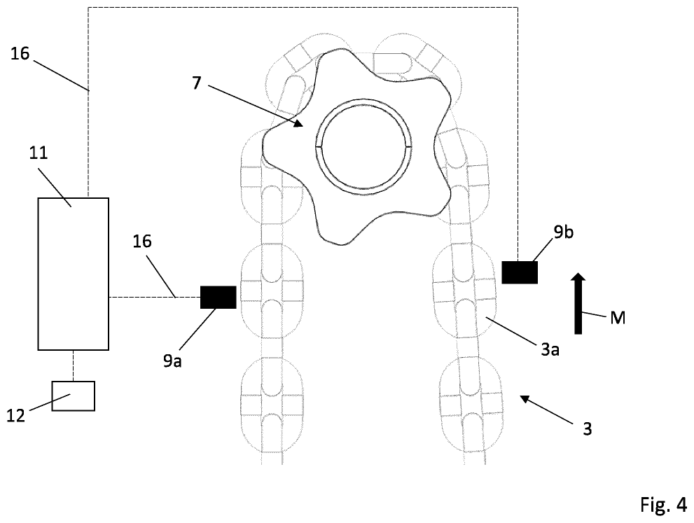

FIG. 4 shows a schematic view of a fourth embodiment of the monitoring system.

In the fourth embodiment, both inductive sensors 9a, 9b are arranged and configured to detect the presence and absence of chain links 3a. As in the other three embodiments, the inductive sensors 9a, 9b are connected to the evaluation unit 11 via signal connections 16 and the evaluation unit 11 is connected to a memory device 12.

The first inductive sensor 9a is located at a different stream side of the sprocket 7 than the second inductive sensor 9b. In other words, considering the chain moving direction M, the first inductive sensor 9a is positioned downstream of the chain sprocket 7, whereas the second inductive sensor 9b is positioned upstream of the chain sprocket 7. That means, if the depicted chain moving direction M is a lifting direction, that the first inductive sensor 9a is arranged at the slack side, while the second inductive sensor 9b is located at the load strand side.

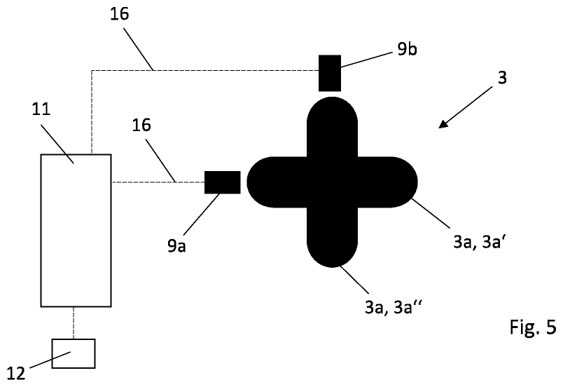

FIG. 5 shows a schematic view of a fifth embodiment of the monitoring system.

The monitoring system according to the fifth embodiment also comprises two inductive sensors 9a, 9b and an evaluation unit 11, to which the two inductive sensors 9a, 9b are connected via signal connections 16. The evaluation unit 11 is connected to a memory device 12.

In this figure a cross-sectional view of the hoist chain 3 is depicted, wherein the first chain link 3a′ and the second chain link 3a″ can be seen. Due to the cross-sectional view, it can well be seen that the even numbered chain links 3a, such as the second chain link 3a″, are in a first plane, whereas the odd numbered chain links 3a, such as the first chain link 3a′, are located in a second plane, which is oriented orthogonal to the first plane.

The first inductive sensor 9a and the second inductive sensor 9b are arranged with an angle of approximately 90° degrees between each other. The two inductive sensors 9a, 9b may be positioned at the same height, i.e. the predetermined distance between the two sensors amounts to zero. The first inductive sensor 9a senses the odd numbered chain links 3a running in the second plane, whereas the second inductive sensor 9b senses the even numbered chain links 3a running in the first plane.

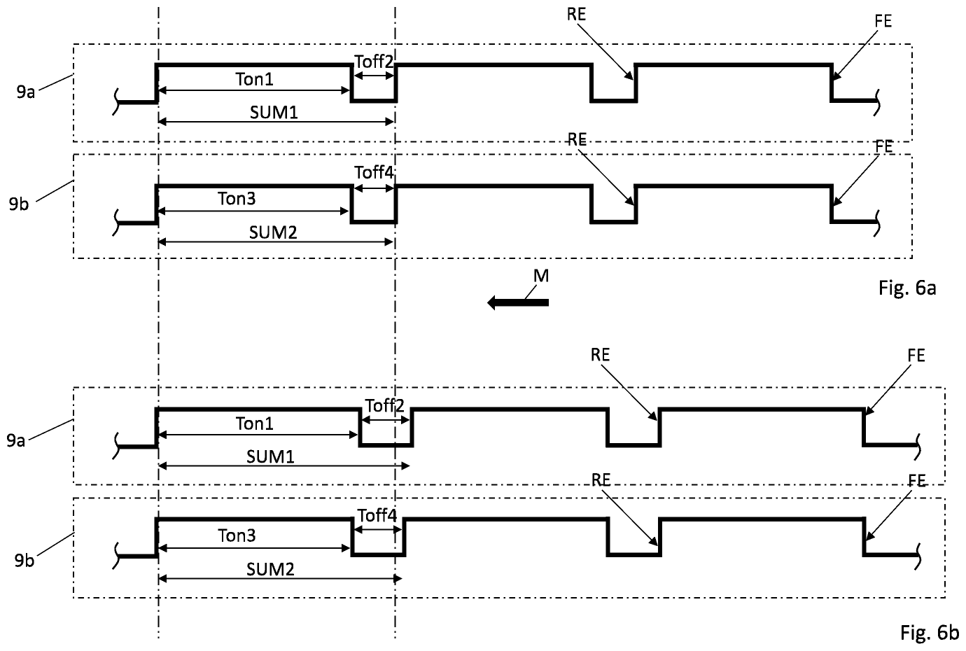

FIG. 6a shows schematic diagram of the signals obtained when performing the monitoring method according to a first embodiment with the second inductive sensor 9b sensing the hoist chain 3 and having the same sensitivity as the first inductive sensor 9a, wherein the hoist chain 3 is in an unworn condition.

So, the method in this case involves two inductive sensors 9a, 9b with the same sensitivity. Both inductive sensors 9a, 9b are arranged and configured to detect the presence and absence of chain links 3a.

In the figure, two signals are shown, wherein the upper one reflects the signal obtained from the first inductive sensor 9a and the lower one reflects the signal obtained from the second inductive sensor 9b. The signals are collected at the same chain speed. Each signal comprises different parts which constitute either an actuated or an unactuated state of the respective inductive sensor 9a, 9b.

The time length of actuated or an unactuated state, which reaches from a rising edge to a subsequent falling edge of the signal or vice versa, is called time interval. With regard to the signal of the first inductive sensor 9a, a first time interval Ton1 reflects the presence of a first chain link 3a′ and a second time interval Toff2 reflects the absence of chain link between the first chain link 3a′ and a third chain link 3a″′. With regard to the second inductive sensor 9b, a third time interval Ton3 reflects the presence of the third chain link 3a″′ and a fourth time interval Toff4 reflects the absence of chain link between the third chain link 3a″′ and a fifth chain link 3a″″′

A first sum SUM1 is formed by adding the first time interval Ton1 to the second time interval Toff2. A second sum SUM2 is formed by adding the third time interval Ton3 to the fourth time interval Toff4.

Since the hoist chain 3 does not show any wear (yet), the first sum SUM1 and the second sum SUM2 are equal to each other. In other words, the equation (Ton1+Toff2)−(Ton3+Toff4), which is used for comparison of the two sums SUM1, SUM2, results to zero.

FIG. 6b shows schematic diagram of the signals obtained when performing the monitoring method according to FIG. 6a, wherein the hoist chain is in a worn condition.

This schematic diagram shows that the first sum SUM1 and the second sum SUM2 are now different to the first and second SUM1, SUM2 shown in FIG. 6a, but also different to each other. The reason for that are longer time intervals Ton1, Toff2, Ton3, and Toff4. That means, the length of some chain links 3a has changed compared to the unworn state shown in FIG. 6a.

Based on such a difference between the first sum SUM1 and the second sum SUM2 an elongation of the hoist chain 3 is determined. The hoist chain 3 may be interpreted as worn. This, however, can depend on the actual use case. It may, for instance, be foreseen that the hoist chain 3 is interpreted as worn, if the difference between the sums SUM1, SUM2 exceeds a predetermined threshold.

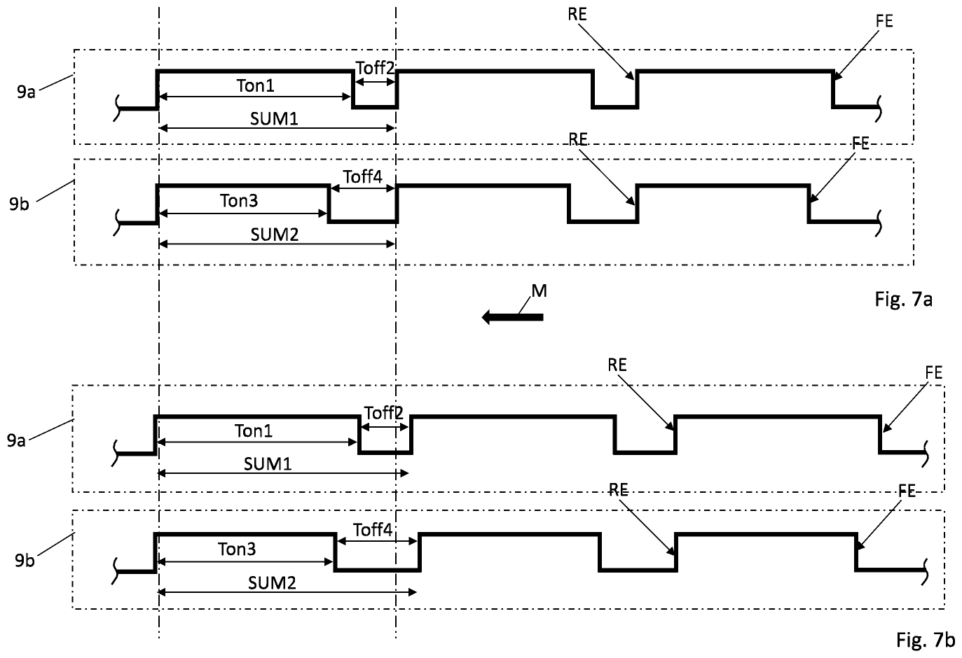

FIG. 7a shows schematic diagram of the signals obtained when performing the monitoring method according to a second embodiment with the second inductive sensor 9b sensing the hoist chain 3 and having a different sensitivity than the first inductive sensor 9a, wherein the hoist chain 3 is in an unworn condition.

In comparison with the schematic diagram shown in FIG. 6a, due to different sensitivities of the two inductive sensors 9a, 9b, the first time interval Ton1 is different to the third time interval Ton3 as well as the second time interval Toff2 is different to the fourth time interval Toff4.

However, the first sum SUM1 is equal to the second SUM2. This is, because the actuation of the first inductive sensor 9a occurs prior to the actuation of the second inductive sensor 9b and ends later, so that the second inductive sensor 9b is triggered for a shorter time period. On the other hand, the second inductive sensor 9b stays unactuated for a longer time period, wherein the difference between the first time interval Ton1 and the third time interval Ton3 is the same as the difference between the second time interval Toff2 and the fourth time interval Toff4.

FIG. 7b shows schematic diagram of the signals obtained when performing the monitoring method according to FIG. 7a, wherein the hoist chain 3 is in a worn condition.

It is extractable from this diagram that the first sum SUM1 of the first and second time intervals Ton1, Toff2 based on signals obtained from the first inductive sensor 9a and the second sum SUM2 of the third and fourth time intervals Ton3, Toff4 based on the signals obtained from the second inductive sensor 9b are not only different to the sums SUM1, SUM2 shown in FIG. 7a, but also different to each other.

Based on such a difference between the first sum SUM1 and the second sum SUM2 an elongation of the hoist chain 3 is determined. For the interpretation of wear the same applies as described in course of FIG. 6b.

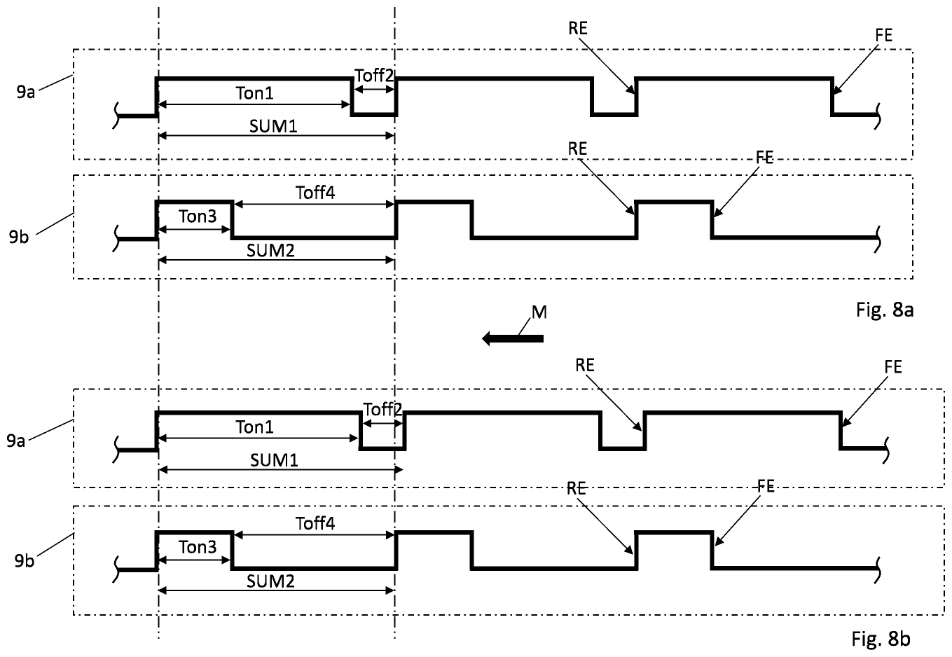

FIG. 8a shows schematic diagram of the signals obtained when performing the monitoring method according to a third embodiment with the second inductive sensor 9b sensing a chain sprocket 7, wherein the hoist chain 3 is in an unworn condition.

In contrast to the embodiments shown in FIGS. 6a, 6b, 7a, and 7b, the second inductive sensor 9b is arranged and configured to detect the presence and absence of teeth 7a of the sprocket 7. The second inductive sensor 9b is arranged and configured in such a way that it senses each sprocket tooth 7a at a region, in which no or only little wear is expected.

Since the gap between the teeth 7a is larger than the width of each tooth 7a at the sensing position of the second inductive sensor 9b, the fourth time interval Toff4 is longer than the third time interval ton3. However, the second inductive sensor 9b and/or its signal can be arranged and/or configured that second sum SUM2 containing the third and fourth time interval Ton3, Toff4 is equal to the fist sum SUM1.

FIG. 8b shows schematic diagram of the signals obtained when performing the monitoring method according to FIG. 8a, wherein the hoist chain is in a worn condition.

Again, since the hoist chain 3 is elongated, the first sum SUM1 in the shown condition differs to the first sum SUM1 in the unworn condition according to FIG. 8a and also to the second sum SUM2. The second sum SUM2 is the same in both conditions, i.e. shown in FIGS. 8a and 8b, since the second inductive sensor 9b senses each sprocket tooth 7a at a region, in which no or only little wear is expected.

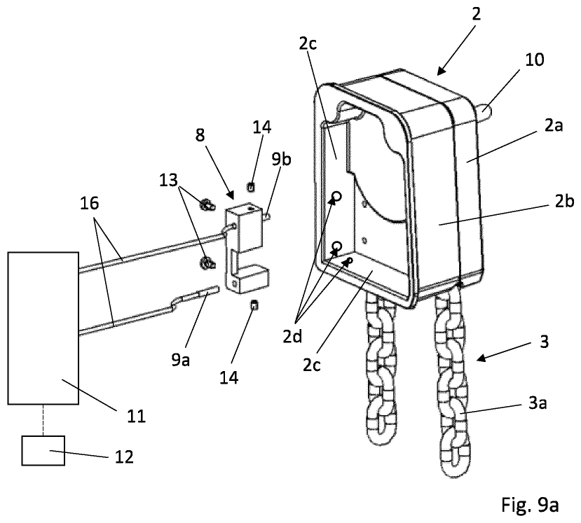

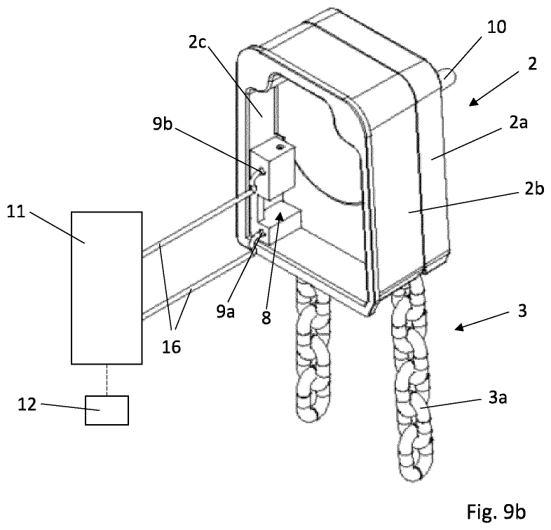

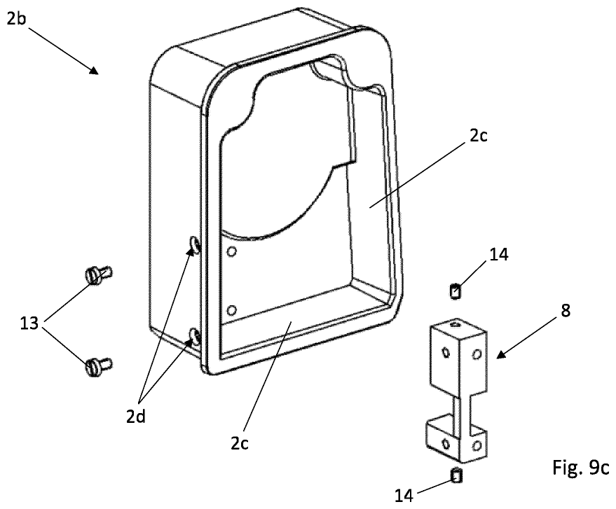

FIG. 9a shows a schematic three-dimensional exploded view of a chain guide 2 with a monitoring system comprising digital inductive sensors 9a, 9b. FIG. 9b shows a schematic three-dimensional view of the chain guide 2 according to FIG. 9a.

The chain guide 2 has a housing, in which the chain sprocket 7 (not visible) is located. The housing comprises a rear housing part 2a and a front housing part 2b. The hoist chain 3 with its chain links 3a is moved or driven by the chain sprocket 7.

The monitoring system comprises two inductive sensors 9a, 9b, which are connected to an evaluation unit 11 of the monitoring system. An adapter 8 is used to optimally arrange the two inductive sensors 9a, 9b for sensing the hoist chain 3. Each inductive sensors 9a, 9b is fixed to the adapter 8 by means of a pin 14. The adapter 8 is mounted to this part of the housing by means of bolts 13 using bore holes 2d. Side walls 2c of the front housing part 2b are used to align the adapter 8.

FIG. 9c shows a further schematic three-dimensional exploded view of the chain guide 2 according to FIG. 9a.

In this view only the front housing part 2b is depicted. The bolts 13 for mounting the adapter 8 to the front housing part 2b can well be seen.

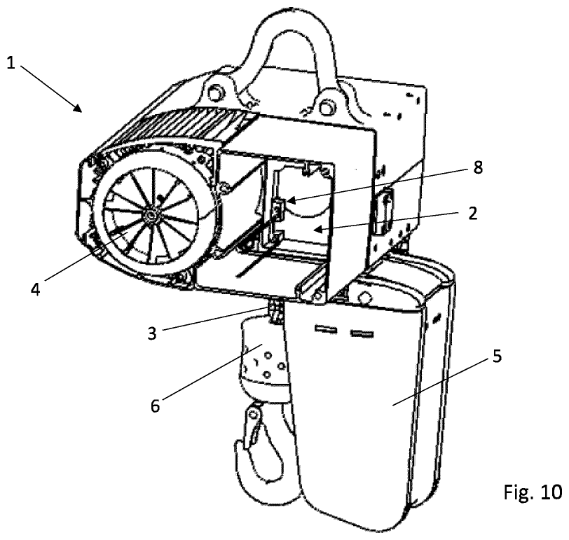

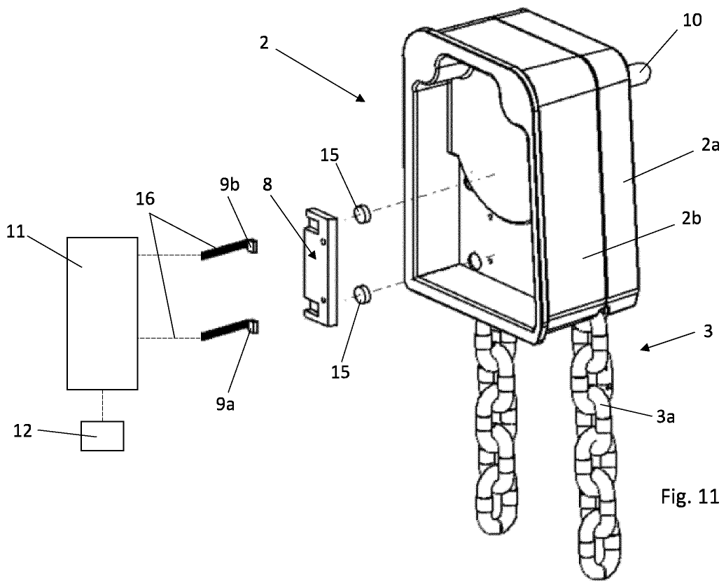

FIG. 10 shows a schematic three-dimensional view of a chain hoist 1 with a chain guide 2 according to FIG. 9a.

Apart from the chain guide 2, the chain hoist 1 further comprises an electric motor 4, a gear box (not shown) and a chain box 5 for temporarily storing the unused part of the hoist chain 3. At the free end of the hoist chain 3 a hook 6 is attached, which can be used to attach the hoist chain 3 to a load in order to lift and/or lower the load.

FIG. 11 shows a schematic three-dimensional exploded view of a chain guide 2 with a monitoring system comprising analog inductive sensors 9a, 9b.

Similar to the embodiment shown in FIGS. 9a to 9c, an adapter 8 is used to position and fix the two inductive sensors 9a, 9b to the housing of the chain guide 2, in particular the front housing part 2b. Magnets 15 are used in case the inductive senor 9a, 9b is an analog inductive sensor 9a, 9b.

Although the description of the figures refers to an inductive sensor, the same applies to other types of sensors, e.g. a mechanical switch or ultra sound sensor.

A person skilled in the art will find it obvious that the basic idea of the invention may be implemented in many different ways. The method and the monitoring system are thus not restricted to the examples described above but may vary within the scope of the claims.

### List of Reference Numerals

1 chain hoist
2 chain guide
2a rear housing part
2b front housing part
2c sidewall
2d bore hole
3 hoist chain
3a chain link
3a′ first chain link
3a″ second chain link
3a′″ third chain link
3a″″ fourth chain link
3a″″′ fifth chain link
4 motor
5 chain box
6 hook
7 chain sprocket
7a tooth
7a′ first tooth
7a″ second tooth
8 sensor adapter
9a first inductive sensor
9b second inductive sensor
10 fixation element
11 evaluation unit
12 memory device
13 bolts
14 pin
15 magnet
16 signal connection
FE falling edge
L predetermined distance (between the inductive sensors)
LE leading edge
M chain moving direction
RE rising edge
SF sensor field
SUM1 first sum
SUM2 second sum
TE trailing edge
Ton1 first time interval
Toff2 second time interval
Ton3 third time interval
Toff4 fourth time interval

1. A method for continuous condition monitoring of a hoist chain comprising the steps of
a) detecting with a first sensor a presence and an absence of chain links,
b) determining with an evaluation unit, using a signal obtained from the first sensor, a first time interval reflecting the presence of a first chain link, a second time interval reflecting the absence of chain link between the first chain link and a third chain link, a third time interval reflecting the presence of the third chain link, and a fourth time interval reflecting the absence of chain link between the third chain link and a fifth chain link,
c) determining with the evaluation unit a first sum of the first time interval and the second time interval as well as a second sum of the third time interval and the fourth time interval,
d) determining with the evaluation unit a chain speed, and
e) comparing with the evaluation unit the first sum with the second sum in order to determine an elongation of the hoist chain, wherein each time interval was determined at the same chain speed.

2. A method for continuous condition monitoring of a hoist chain comprising the steps of
a) detecting with a first sensor a presence and an absence of chain links,
a′) detecting with a second sensor a presence and an absence of teeth of a chain sprocket or the presence and the absence of chain links,
b′) determining with an evaluation unit, using a signal obtained from the first sensor, a first time interval reflecting the presence of a first chain link and a second time interval reflecting the absence of chain link between the first chain link and a third chain link,
b″) determining with the evaluation unit, using a signal obtained from the second sensor, a third time interval reflecting the presence of a first tooth or the presence of the first chain link or a second chain link or the third chain link and a fourth time interval reflecting the absence of tooth between the first tooth and a second tooth or the absence of chain link between the first chain link and the third chain link or between the second chain link and a fourth chain link or between the third chain link and a fifth chain link,
c) determining with the evaluation unit a first sum of the first time interval and the second time interval as well as a second sum of the third time interval and the fourth time interval,
d) determining with the evaluation unit a chain speed, and
e) comparing with the evaluation unit the first sum with the second sum in order to determine an elongation of the hoist chain, wherein each time interval was determined at the same chain speed.

3. The method according to claim 1, wherein the method comprises repeating the steps a) to e) in case the chain speed changes.

4. The method according to claim 2, wherein the chain speed is determined by comparing the signal obtained from the first sensor with the signal obtained from the second sensor.

5. The method according to claim 1, wherein the method includes detecting with the first sensor and/or the second sensor an air gap between the respective sensor and the hoist chain.

6. The method according to claim 5, wherein the method includes determining with the evaluation unit the size of the air gap in order to take possible air gap generated deviations during detection with the respective sensor into account when determining the elongation of the hoist chain.

7. The method according to claim 2, wherein the first sensor and the second sensor have different actuation sensitivities.

8. The method according to claim 2, wherein the first sensor and the second sensor work independently from each other.

9. The method according to claim 1, wherein the method includes comparing with the evaluation unit a difference between the first sum and second sum with a predetermined threshold.

10. The method according to claim 9, wherein the method includes generating, in particular with the evaluation unit, an output signal in case the difference exceeds the predetermined threshold.

11. A monitoring system for continuous condition monitoring of a hoist chain comprising
a first sensor, wherein the first sensor is arranged and configured to detect a presence and an absence of chain links,
a memory device configured to collect and save signals or signal data obtained from the first sensor, and
an evaluation unit configured to carry out the method according to claim 1.

12. The monitoring system according to claim 11, wherein the monitoring system further comprises a second sensor fixedly arranged at a predetermined distance from the first sensor, wherein the second sensor is arranged and configured to detect a presence and an absence of teeth of a chain sprocket or the presence and the absence of chain links, and in that the memory device is configured to collect and save signals or signal data obtained from the second sensor, and in that the evaluation unit is configured to carry out a method for continuous condition monitoring of a hoist chain comprising the steps of
a) detecting with a first sensor a presence and an absence of chain links,
a′) detecting with a second sensor a presence and an absence of teeth of a chain sprocket or the presence and absence of chain links,
b′) determining with an evaluation unit, using a signal obtained from the first sensor, a first time interval reflecting the presence of a first chain link and a second time interval reflecting the absence of chain ink between the first chain link and a third chain link,
b″) determining with an evaluation unit, using a signal obtained from the second sensor, a third time interval reflecting the presence of first tooth or a presence of the first chain link or a second chain link or the third chain link and a fourth time interval reflecting the absence of tooth between the first and second tooth or the absence of chain link between the first chain link and the third chain link or between the second chain link and a fourth chain link between the third chain link and a fifth chain link.
c) determining with the evaluation unit a first sum of the first time interval and the second time interval as well as a second sum of the third time interval and the fourth time interval,
d) determining with the evaluation unit a chain speed, and
e) comparing with the evaluation unit the first sum with the second sum in order to determine an elongation of the hoist chain, wherein each time interval was determined at the same chain speed.

13. The monitoring system according to claim 12, wherein both the first sensor and the second sensor are arranged upstream or downstream of the chain sprocket or the first sensor and the second sensor are arranged at different stream sides of the chain sprocket.

14. The monitoring system according to claim 12, wherein the first sensor and the second sensor are arranged with an angle of approximately 90° degrees between each other.

15. The monitoring system according to claim 12, wherein the first sensor has a first sensitivity and the second sensor has a second sensitivity being different from the first sensitivity.

16. A chain hoist comprising a monitoring system according to claim 11, wherein the monitoring system is in particular arranged at or in a chain guide of the chain hoist.
